(19) United States
(12) Patent Application Publication
(10) Pub. No.: US 2016/0210710 A1
(43) Pub. Date: Jul. 21, 2016

(54) METHOD, APPARATUS AND SYSTEM FOR EARNING OWNERSHIP RIGHTS OF THE PRODUCT OR PRODUCTS OF A COLLABORATIVE PROJECT

(71) Applicant: Company Inc. Ltd., London (GB)

(72) Inventor: Philip V. Glennon, London (GB)

(73) Assignee: Company Inc. Ltd., London (GB)

(21) Appl. No.: 14/994,314

(22) Filed: Jan. 13, 2016

Related U.S. Application Data
(60) Provisional application No. 62/103,688, filed on Jan. 15, 2015.

(51) Int. Cl. G06Q 50/18; G06Q 10/10

(52) U.S. Cl. CPC G06Q 50/184; G06Q 10/101

(57) ABSTRACT

A method, apparatus and system for earning ownership rights of the product or products of a collaborative project.

A computer-implemented method for earning ownership rights of the product or products of a collaborative project comprising the steps of:
i. creating an online project space within which users can collaborate on a project;
ii. recording the time spent by each user working on the project;
iii. assigning a share of the ownership of the product or products of the project to each user on completion of the project.

This application claims priority to U.S. Provisional Patent Application No. 62/103,688 filed on 15 Jan. 2015 and titled “A Method, Apparatus and System for Earning Ownership Rights of the Product or Products of a Collaborative Project”.

### FIELD OF INVENTION

The present invention relates to a method, apparatus and system for earning ownership rights of the product or products of a collaborative project based on work carried out by members of a collaborative team.

### BACKGROUND

Online collaboration is becoming increasingly widely used as a method of working on a project or projects. There are a number of methods which can be used to reward participants, such as for example payment for hours worked, tasks completed etc. or rewarding participants with an electronic or online token or currency that is indicative of an ownership proportion of the business.

One issue with previously known methods of rewarding participants is that founding members of a company can lose certain ownership rights on leaving the project, particularly if the company for which they are working already exists as a legal entity while they are carrying out work.

It is an object of the present invention to provide a method for earning ownership rights of the product or products of a collaborative project by working as a member of an online team which goes some way to overcoming the abovementioned disadvantages or which at least provides the public or industry with a useful choice.

It is a further object of the present invention to provide for earning ownership rights of the product or products of a collaborative project by working as a member of an online team which goes some way to overcoming the abovementioned disadvantages or which at least provides the public or industry with a useful choice.

It is a further object of the present invention to provide an apparatus for earning ownership rights of the product or products of a collaborative project by working as a member of an online team which goes some way to overcoming the abovementioned disadvantages or which at least provides the public or industry with a useful choice.

Further objects and advantages of the invention will be brought out in the following portions of the specification, wherein the detailed description is for the purpose of fully disclosing the preferred embodiment of the invention without placing limitations thereon.

The background discussion (including any potential prior art) is not to be taken as an admission of the common general knowledge.

### SUMMARY OF THE INVENTION

The term “comprising” as used in this specification and indicative independent claims means “consisting at least in part of”. When interpreting each statement in this specification and indicative independent claims that includes the term “comprising”, features other than that or those prefaced by the term may also be present. Related terms such as “comprise” and “comprises” are to be interpreted in the same manner.

As used herein the term “and/or” means “and” or “or”, or both.

As used herein “(s)” following a noun means the plural and/or singular forms of the noun.

In an aspect, the invention may broadly be said to consist in a computer-implemented method for earning ownership rights of the product or products of a collaborative project, comprising the steps of:
i. creating an online project space within which users can collaborate on a project;
ii. recording the time spent by each user working on the project;
iii. assigning a share of the ownership of the product or products of the project to each user on completion of the project. This is advantageous as it allows ownership rights to be earned using time spent working on the platform to calculate ownership upon exit.

In an embodiment, the ownership shares are assigned to the users via ownership of a share in a registered company. This is advantageous as it allows users to have equity in a company.

In an embodiment, the ownership shares are assigned to the users via a legally binding document. This is advantageous if the users do not wish to register a company, but still wish to have ownership value in their work based on their contribution.

In an embodiment, at least part of the product of the collaborative project comprises Intellectual Property. This allows users to extract the full value of their contribution.

In an embodiment, the method further comprises the initial step of creating a smart contract configured to interact with the online project space to record time spent by users working on the project. This allows for automatic recordal of the time users spend working on the project, and for calculation of ownership portions upon platform exit.

In an embodiment, the smart contract resides on a decentralized network. This provides transparency, as it may be viewed by anyone.

In an embodiment, the smart contract is configured to execute on completion of the project and prepare an assignment of Intellectual Property rights. This allows for calculation of ownership portions upon platform exit.

In an embodiment, the smart contract is configured to prepare an application to register a company. This is advantageous as it automatically allows users to have equity in a company based on their individual contribution.

In an embodiment, the relative size of the share of the ownership of the product or products of the project assigned to an individual user depends on the relative amount of recorded time spent working on the project in comparison to the other users. This allows users to extract value from their work in direct relation to their contribution.

In an embodiment, the relative amount of recorded time for any user can be weighted by a multiplier factor. This allows for more skilled or experienced users to extract a greater value from their contribution.

### BRIEF DESCRIPTION OF THE DRAWINGS

Further aspects of the invention will become apparent from the following description which is given by way of example only and with reference to the accompanying drawings which show embodiments of the device by way of example, and in which:

FIG. 1 is a schematic overview of the elements of a system suitable for implementing an embodiment of the present invention, with the main building blocks or system elements and the main connections between these elements shown, the system recording time spent by users working on a project in a project space hosted on a collaboration platform, then transferring ownership of Intellectual Property rights to a registered company and assigning shares in that company to the users on launch/commencement of commercial activity.

FIG. 2 is a schematic overview of a variation of the system shown in FIG. 1 where the relative size of the portion of a registered company assigned to a user is calculated from the amount of recorded time an individual user has spent working on the product relative to the time spent by other users.

FIG. 3 is a schematic overview of a system that records time spent by users working on a project in a project space hosted on a collaboration platform, with ownership of Intellectual Property rights transferred to users via an assignment on launch/commencement of commercial activity, and with the relative share of the overall Intellectual Property assigned to each individual user based on the overall time spent working on the project relative to the other users.

### DETAILED DESCRIPTION OF THE INVENTION

Embodiments and variations thereof of the present invention will now be described with reference to the figures.

The present invention provides a method, system and apparatus for earning ownership rights of the product or products of a collaborative project, based on the work carried out by each member. An embodiment, and variations of this embodiment, suitable for putting the invention into effect will now be described with reference where applicable to the figures.

In this embodiment, and with reference to FIG. 1, a group of people or project team work online to collaborate on a commercial product, in a similar manner to an open source project. The commercial product may be for example software code for an app. or similar. The online space or project space 1 for the commercial product is created by a principal user or users 2a, who will normally achieve this by joining an existing framework or platform (a collaboration platform) and then creating a ‘virtual company’ or ‘collaboration project’ on the platform for the project space 1. Alternatively they can create a new collaboration platform, and then create a ‘virtual company’ on the new platform for the project space 1. The framework or platform can be a server, an enterprise data warehouse, an operational data store, a data mart, a storage array, or similar, and can be a centralized location, or a distributed network.

As part of the setup process for setting up the virtual company, a smart contract is created. The ‘smart contract’ functions as a contact with computer code which can receive inputs and which can output to another system. The smart contract can ‘self-execute’. In this embodiment, the ‘smart contract’ resides on a decentralized network. One purpose of the smart contract is to provide transparency it can be viewed by anyone as it resides on a decentralized network. Another purpose is to calculate ownership proportions upon platform exit. Alternatively, the smart contract is automatically created by the platform on set up.

A further part of the setup process is to stipulate that all Intellectual Property created while working on the commercial product is held by a 3 rd party (e.g. on the collaboration platform).

The next step is for individual users 2b to apply to participate or collaborate on the commercial product. If not already members of the platform, they will join the platform before applying. Once they begin work on the commercial product within the project space 1. The users 2b either submit periodic (e.g. weekly) timesheets, or working time is calculated by another means and the time spent (and user-time spent working on the commercial product) are registered and recorded by the smart contract.

In this embodiment, as the team are working online, and may be geographically separated, rather than working in proximity on a local (office) network, each member of the team uses their own personal terminal (for example a laptop, PDA/tablet device, mobile or smartphone, or desktop PC) to log into the project space 1. The project space 1 stores details of the commercial product which the team are working on, and allows them to make changes, add new material, collaborate, and carry out any other tasks such as are necessary.

The users log into and communicate with the project space 1 by way of any suitable communication system for example, wireless transmission, transmission via an established telephone network (mobile or landline), via a built-in hardwired grid, etc. A combination of these elements can also be used to transmit and receive data to and from the project space 1.

The users 2a, 2b work on the commercial product within the project space, with the virtual company operating as a non-legal entity, until such time that it is decided to exit the platform in accordance with any preexisting agreements. At this point the virtual company ‘exits to the real world’ and becomes a legal entity i.e., a registered company. At this point the ‘smart contract’ executes and triggers an application to register the company (e.g., via efiling), and an assignment of Intellectual Property rights is prepared, which when executed transfers ownership of all the Intellectual Property rights associated with the commercial product that were created while working on the commercial product to the registered company. This is electronically signed by the users 2a, 2b.

This system allows for ownership rights to be earned on a platform (e.g., a virtual company on an electronic system) using time spent working on the platform to calculate ownership upon exit. That is, any user who has spent a significant amount of time working on a project is entitled to an equal share of the ownership with all others who have spent a significant time working on the project. The amount of time could be set as a threshold amount by the smart contract for example 200 hours. Ownership provisions are then transferred to either a legally binding document or a registered company (e.g. a Limited company in England and Wales or a Delaware State Limited Liability Company).

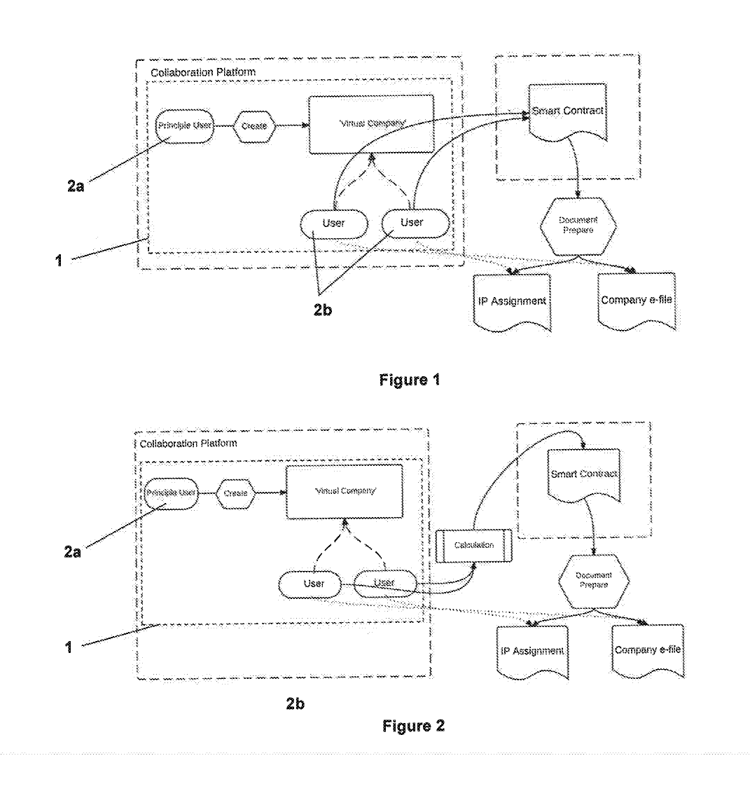

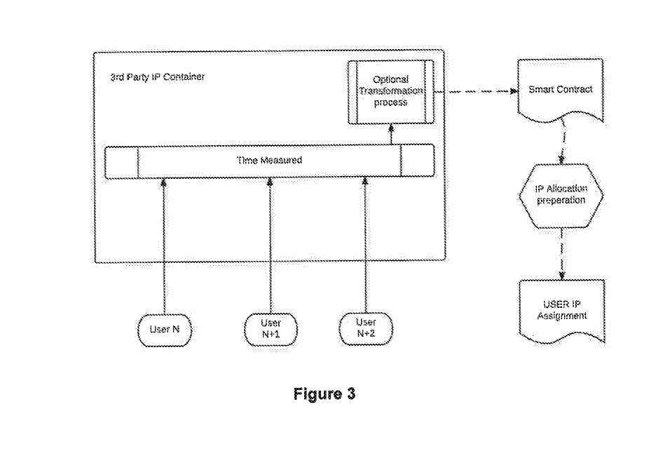

A variation on this arrangement is shown in FIG. 2. In this variation the relative size or overall percentage of the company that is owned by the user depends on the amount of time they have spent working on the project relative to the amount of time other users have spent. The ownership portions/percentages are calculated based on information submitted in the timesheets. That is, the more time an individual user has spent working on the product (relative to the time spent by other users), the greater the ownership share will be for that user. That is, the system allows for ownership rights to be earned, using time spent working in the project space 1 to calculate ownership upon exit.

There are two main ways this can be calculated. Firstly, a basic ‘time spent’ calculation (every user earns the same percentage share per time spent), so for example:

User 1: 100 hours spent working=29% ownership

User 2: 50 hours spent working=14% ownership

User 3: 200 hours spent working=57% ownership
In the second variation, the time spent is weighted, depending on the user. That is, a user having particular skills or experience could have their time weighted by a multiplier factor so that they earn relatively more for each hour they spend working than a user with less experience would do. For example a normal user would earn 1 ‘point’ for each hour they spend, while a skilled user with a ‘2×’ weighting factor applied to their work would earn 2 ‘points’ for every hour spent contributing, a user with a ‘1.5×’ weighting factor applied to their work would earn 1.5 ‘points’ for every hour spent contributing, etc. Points can then be tallied and simple arithmetic applied to calculate ownership share upon platform exit.
In a variation of the two examples given above (and with reference to FIG. 3), the Intellectual Property is not assigned to a registered company by the users on exit from the platform to the real world. At the start of the process a third party Intellectual Property holder is established. The users contribute their time as outlined for either of the two examples above, with the time recorded as outlined (times one, or with a weighting factor). On exit, the Smart Contract applies the necessary calculations and outputs to an Intellectual Property contract preparation module. A share of the overall Intellectual Property created during the project is assigned to users based on the output of the smart contract.

In a variation of the above example, where a third party Intellectual Property holder is established, a smart contract is generated, and the users contribute by logging in via a decentralized network, in the same or a similar manner to that outlined above. The contribution of each individual user is measured by ‘time spent’, with the time recorded as outlined (times one, or with a weighting factor). On exit, the Smart Contract applies the necessary calculations and outputs to an Intellectual Property contract preparation module, and (if applicable) triggers an application to register the company (e.g., via e-filing). In this variation, the users either e-sign or physically sign the documents as necessary in order to make them legally binding. If any of the users do not sign, for whatever reason, the system is configured so that the Intellectual Property for that user can be redistributed, for example among the other users or reassigned to the platform owner. That is, the principal user or users 2a triggers a ‘not signed’ state within the system, and provides details of the non-signing user or users when prompted by the system. This causes the system to withdraw the previously generated documents and reissue fresh/new documents that reflect the redistribution of the Intellectual Property among the other users, or the reassignment to the platform owner.

It will be understood that the system herein described includes one or more elements that are arranged to perform the various functions and methods as described herein. The embodiments herein described are aimed at providing the reader with examples of how various modules and/or engines that make up the elements of the system may be interconnected to enable the functions to be implemented. Further, the embodiments of the description explain, in system related detail, how the steps of the herein described method may be performed. The conceptual diagrams are provided to indicate to the reader how the various data elements are processed at different stages by the various different modules and/or engines.

It will be understood that the arrangement and construction of the modules or engines may be adapted accordingly depending on system and user requirements so that various functions may be performed by different modules or engines to those described herein, and that certain modules or engines may be combined into single modules or engines.

It will be understood that the modules and/or engines described may be implemented and provided with instructions using any suitable form of technology. For example, the modules or engines may be implemented or created using any suitable software code written in any suitable language, where the code is then compiled to produce an executable program that may be run on any suitable computing system. Alternatively, or in conjunction with the executable program, the modules or engines may be implemented using any suitable mixture of hardware, firmware and software. For example, portions of the modules may be implemented using an application specific integrated circuit (ASIC), a system-on-a-chip (SoC), field programmable gate arrays (FPGA) or any other suitable adaptable or programmable processing device.

The methods described herein may be implemented using a general purpose computing system specifically programmed to perform the described steps. Alternatively, the methods described herein may be implemented using a specific computer system such as a data sorting and visualization computer, a database query computer, a graphical analysis computer, a gaming data analysis computer, a manufacturing data analysis computer, a business intelligence computer etc., where the computer has been specifically adapted to perform the described steps on specific data captured from an environment associated with a particular field.

What is claimed is:

1. In a computing system, a computer-implemented method for earning ownership rights of the product or products of a collaborative project comprising the steps of:
i. creating an online project space within which users can collaborate on a project;
ii. recording the time spent by each user working on the project;
iii. assigning a share of the ownership of the product or products of the project to each user on completion of the project.

2. A method for earning ownership rights of the product or products of a collaborative project as claimed in claim 1 wherein the ownership shares are assigned to the users via ownership of a share in a registered company.

3. A method for earning ownership rights of the product or products of a collaborative project as claimed in claim 1 wherein the ownership shares are assigned to the users via a legally binding document.

4. A method for earning ownership rights of the product or products of a collaborative project as claimed in any one of claims 1 to 3 wherein at least part of the product of the collaborative project comprises Intellectual Property.

5. A method for earning ownership rights of the product or products of a collaborative project as claimed in any one of claims 1 to 4 further comprising the initial step of creating a smart contract configured to interact with the online project space to record time spent by users working on the project.

6. A method for earning ownership rights of the product or products of a collaborative project as claimed in claim 5 wherein the smart contract resides on a decentralized network.

7. A method for earning ownership rights of the product or products of a collaborative project as claimed in claim 5 or claim 6 wherein the smart contract is configured to execute on completion of the project and prepare an assignment of Intellectual Property rights.

8. A method for earning ownership rights of the product or products of a collaborative project as claimed in any one of claims 5 to 7 wherein the smart contract is configured to prepare an application to register a company.

9. A method for earning ownership rights of the product or products of a collaborative project as claimed in any one of claims 1 to 8 wherein the relative size of the share of the ownership of the product or products of the project assigned to an individual user depends on the relative amount of recorded time spent working on the project in comparison to the other users.

10. A method for earning ownership rights of the product or products of a collaborative project as claimed in claim 9 wherein the relative amount of recorded time for any user can be weighted by a multiplier factor.
